(19) United States
(12) Patent Application Publication
(10) Pub. No.: US 2007/0082180 A1
(43) Pub. Date: Apr. 12, 2007

(54) SYSTEM AND METHOD FOR MAKING DECORATIVE BUILDING PANELS HAVING A VARIEGATED APPEARANCE

(76) Inventor: Daniel W. King, Copley, OH (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/539,822

(22) Filed: Oct. 9, 2006

Related U.S. Application Data
(60) Provisional application No. 60/596,650, filed on Oct. 10, 2005.
(60) Provisional application No. 60/739,906, filed on Nov. 23, 2005.

(51) Int. Cl. B32B 1/00

(52) U.S. Cl. 428/174

(57) ABSTRACT

A system and method are provided for producing decorative panels having a variegated appearance. The system includes a painting station, a wiping station, and a curing station for creating the variegated appearance on the panel. The painting station applies paint onto a front surface of the panel and the wiping station smears the paint along the peaks while avoiding the paint in the valleys. The wiper moves laterally across the panel, i.e., from edge to edge, generally in the same lateral direction as the peaks and valleys, while the panel is advanced through the wiping station in a longitudinal direction. The panel is then passed to the curing station to cure the paint with a UV light source.

### CROSS-REFERENCE TO RELATED APPLICATIONS

This application claims the benefit of U.S. Provisional Patent Application Ser. Nos. 60/596,650, filed Oct. 10, 2005, and 60/739,906, filed Nov. 23, 2005, the advantages and disclosures of both of which are hereby incorporated by reference.

### FIELD OF THE INVENTION

The present invention relates to a system and method for making decorative building panels having a variegated appearance. More specifically, the present invention relates to thermoplastic panels having peaks and valleys of varying heights with paint applied to the peaks and valleys and wiped along the peaks to provide the variegated appearance.

### BACKGROUND OF THE INVENTION

Several systems and methods are known for decorating wood panels, particularly pressed wood panels, to add a variegated appearance to the panels and give the panels the appearance of real wood. In one method, shown in U.S. Pat. No. 3,847,646 to Daunheimer et al., stain is applied to a pressed wood panel and then selectively wiped from the panel to create a variegated surface. In Daunheimer et al., the wood is advanced on a conveyor in a longitudinal direction to a stain applicator to receive a thin layer of stain. From the stain applicator, the panel moves through a series of wipers and rollers. The wipers and rollers are configured to remove the stain from peaks formed in the panel, while pushing the stain into valleys formed between adjacent peaks. Here, the peaks and valleys lie in the longitudinal direction of the panel and the wipers and rollers act in the longitudinal direction to wipe the stain from the peaks into the valleys in the longitudinal direction.

U.S. Pat. No. 3,936,541 to Plowman et al. discloses a system that utilizes a first roller for applying a pigmented material to a wood panel. The panel in Plowman et al. also includes peaks and valleys extending in a longitudinal direction of the panel. The panel is advanced in the longitudinal direction from the first roller to a second, separate roller to wipe the pigmented material from the peaks of the panel. The first roller applies the pigmented material to both the peaks and valleys of the panel in the longitudinal direction, while the second roller is configured to remove the pigmented material from the peaks in the longitudinal direction, thus leaving the pigmented material in the valleys. Since the panel is of a first color, and the pigmented material is of a second color, different than the first color, the panel is produced with a variegated appearance.

Neither Daunheimer et al., nor Plowman et al., suggest a system or method of applying stain or pigmented material to a panel and wiping the stain or pigmented material on the panel in a lateral direction, opposite to the longitudinal direction of the panel. This may be particularly advantageous in producing panels that are intended to resemble cedar shake shingles with the peaks and valleys of the panel extending laterally between top and bottom edges of the panel, and not in the longitudinal direction of the panel.

The prior art also discloses systems and methods of providing non-wood panels, such as thermoplastic panels, with a variegated appearance to give the panels the appearance of cedar shake shingles. For example, a laminate having a variegated appearance may be mounted to a thermoplastic panel using an adhesive. One drawback to the laminate is that over time, the laminate undesirably peels off from the panel. Furthermore, when the panel is viewed at a close distance, the laminate is clearly discernible. In another prior art method, two differently colored thermoplastic materials are co-extruded to create the variegated appearance. When co-extruding the two materials, there is little control over creating the variegated appearance and the resultant panel does not create the authentic appearance of actual wood.

Therefore, there is a need in the art for a system and method of applying paint to a thermoplastic sheet of material to produce decorative building panels having a variegated appearance approaching that of real wood that overcomes the disadvantages that characterize the prior art.

### SUMMARY OF THE INVENTION

A system for decorating a sheet of thermoplastic material such as a panel is provided. The sheet of thermoplastic material is initially formed with peaks and valleys of varying height extending between opposed top and bottom edges. The system comprises a painting station including an applicator for applying paint to the peaks and valleys of the sheet of material. The sheet of material has a first color and the paint has a second color different than the first color. A wiping station is disposed downstream of the painting station. The wiping station includes a wiper for wiping the paint along the peaks while the paint remains substantially untouched in the valleys of the sheet of material. As a result, the paint on the peaks has a different appearance than the paint in the valleys. A conveyor advances the sheet of material through the wiping station in a longitudinal direction, while the peaks and valleys extend between the top and bottom edges in a lateral direction opposite to the longitudinal direction. The wiper moves in the lateral direction opposite to the longitudinal direction of advancement to wipe the paint along the peaks in the lateral direction to provide the sheet of material with vertical striations extending in the lateral direction between the top and bottom edges.

In another aspect of the present invention, the paint that is applied to the sheet of material is a UV curable paint. In this instance, a curing station is spaced from the painting station and the wiping station to cure the UV curable paint and fuse the paint to the sheet of material.

A method of decorating the sheet of thermoplastic material is also provided. The method includes applying the paint to the peaks and valleys of the sheet of material and advancing the sheet of material in the longitudinal direction, while the peaks and valleys extend between the opposed edges in a lateral direction opposite to the longitudinal direction. The method also includes moving the wiper across the sheet of material in the lateral direction from edge to edge while simultaneously advancing the sheet of material in the longitudinal direction. At the same time, the wiper spreads the paint along the peaks in the lateral direction while the paint remains substantially untouched in the valleys of the sheet of material. This provides the sheet of material with the vertical striations.

The present invention provides a system and method for producing decorative building panels that overcome the disadvantages that characterize the prior art. Specifically, the panels formed according to the present invention have a variegated appearance approaching that of natural, real wood siding, such as cedar shake shingles. The variegations extend in substantially the same direction as the peaks and valleys as is the case for cedar shake shingles.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a system for creating a variegated appearance on a panel according to the present invention;

FIG. 2 is an elevational view of the system of FIG. 1;

FIG. 3 is a front view of a painting station of the system applying paint to the panel as the panel moves longitudinally through the painting station;

FIG. 3A is a cross-sectional view of an air knife for applying paint to a butt edge of the panel;

FIG. 4 is a close-up perspective view of a wiping station for moving a wiper laterally across the panels while the panels move longitudinally through the wiping station;

FIG. 5 is a cross-sectional view of a wiper contacting the panel at the wiping station to produce the variegated appearance;

FIG. 6 is a perspective view of an alternative wiper of the present invention;

FIG. 7 is a perspective view of another alternative wiper of the present invention;

FIG. 8 is a perspective view of a corner post and a wiping station for a corner post; and

FIG. 9 is a front view of the panel formed according to the present invention having a variegated appearance.

### DETAILED DESCRIPTION OF THE INVENTION

Referring to the Figures, wherein like numerals indicate like or corresponding parts throughout the several views, a system for producing decorative panels 12 having a variegated appearance is illustrated generally at 10. The decorative panels 12 are preferably siding panels, but the panels 12 may also be used for other purposes. The panels 12 are formed from a rigid thermoplastic material, such as polyvinylchloride or “vinyl”. The panels 12 may be cut from sheets of the rigid thermoplastic material, which are formed into desired shapes in a vacuum forming process or other suitable process, or the panels 12 may be individually formed.

Each panel 12 may be formed to represent a series of adjacent, generally rectangular, shingles, each having a different and distinct wood grain to give the appearance of rough sawn cedar shake shingles or smooth wood shingles when applied to an outer surface of a building. The panels 12 may be formed to include a single row of shingles or multiple rows, such as a double-4 or double-5 siding panel. Each of the panels 12 have a top edge and a bottom edge with a nail hem 16 adjacent to the top edge and a butt flange 18 adjacent to the bottom edge. Each of the panels 12 can be interlocked with adjacent panels 12 using principles well known in the art. Each of the panels 12 also includes a plurality of peaks 20 and valleys 22 of varying height extending between the top and bottom edges. The peaks 20 and valleys 22 generally run between the edges, i.e., between the nail hem 16 and the butt flange 18, in a lateral direction A across the panels 12 to generally give the panels 12 a front surface that ultimately emulates wood grain.

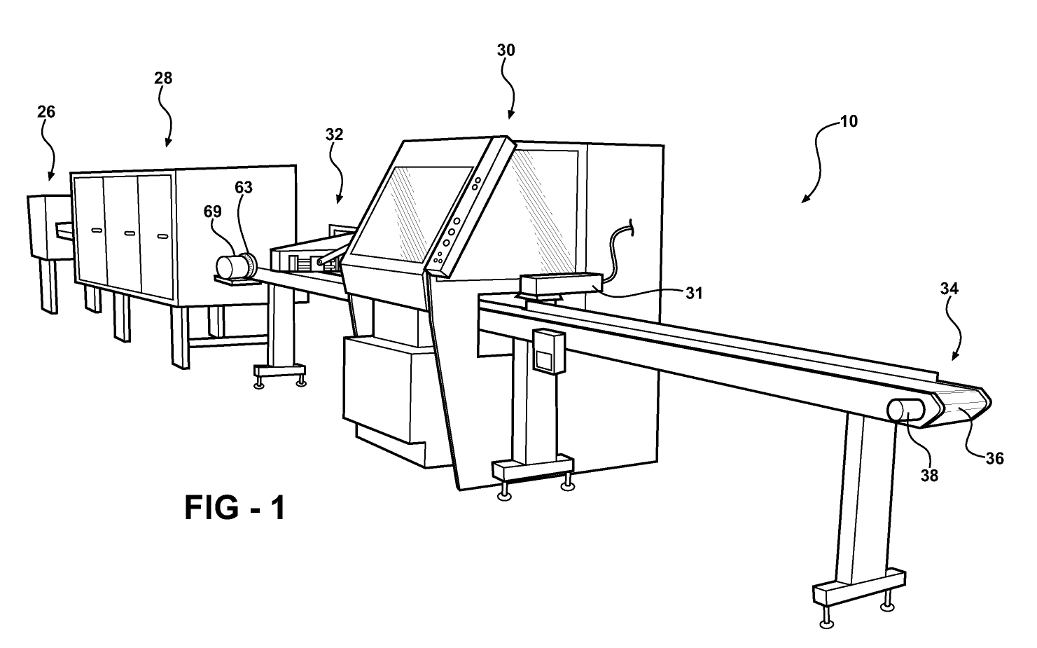

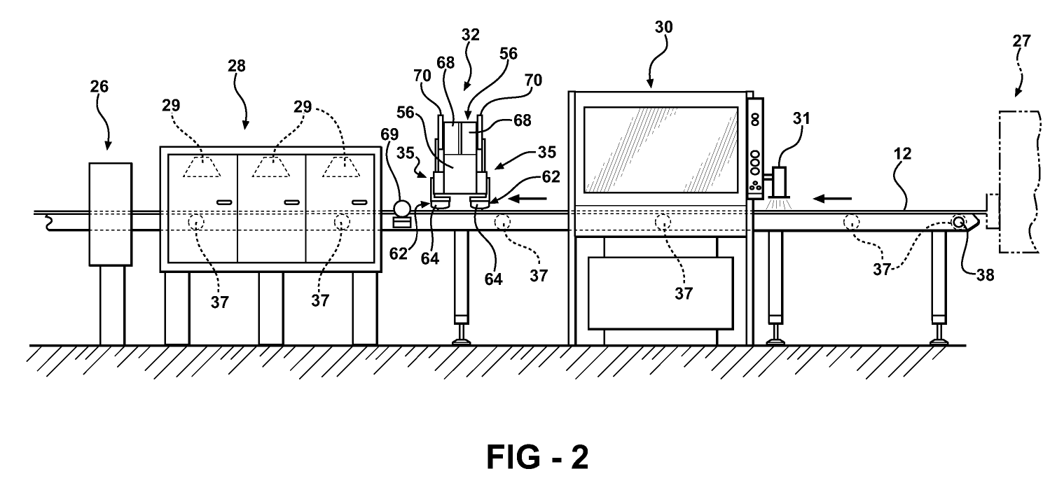

Referring to FIG. 1, the system 10 for giving the panels 12 a variegated appearance is shown. The system 10 includes a painting station 30, a wiping station 32, and a curing station 28. It is to be appreciated that the painting station 30, the wiping station 32, and the curing station 28 could be used to decorate previously formed panels 12 from inventory that are fed, one at a time, into the system 10, or, alternatively, a continuous panel of the thermoplastic material could enter the system 10 as it is formed, prior to being cut into shorter, individual panels 12. In the latter case, the continuous panel of thermoplastic material would enter the system 10 from an exit section 27 (see FIG. 2) of a continuous panel forming system (not shown). The continuous panel forming system and process may be like that shown in U.S. Pat. No. 7,008,213 to King, hereby incorporated by reference, or any other suitable continuous panel forming system or process. The term “sheet of thermoplastic material” as used in the description and the claims can refer to either an individual panel 12 previously formed or a continuous panel of thermoplastic material. For simplicity, the system and methods of the present invention will be described with reference to decorating previously formed, individual panels.

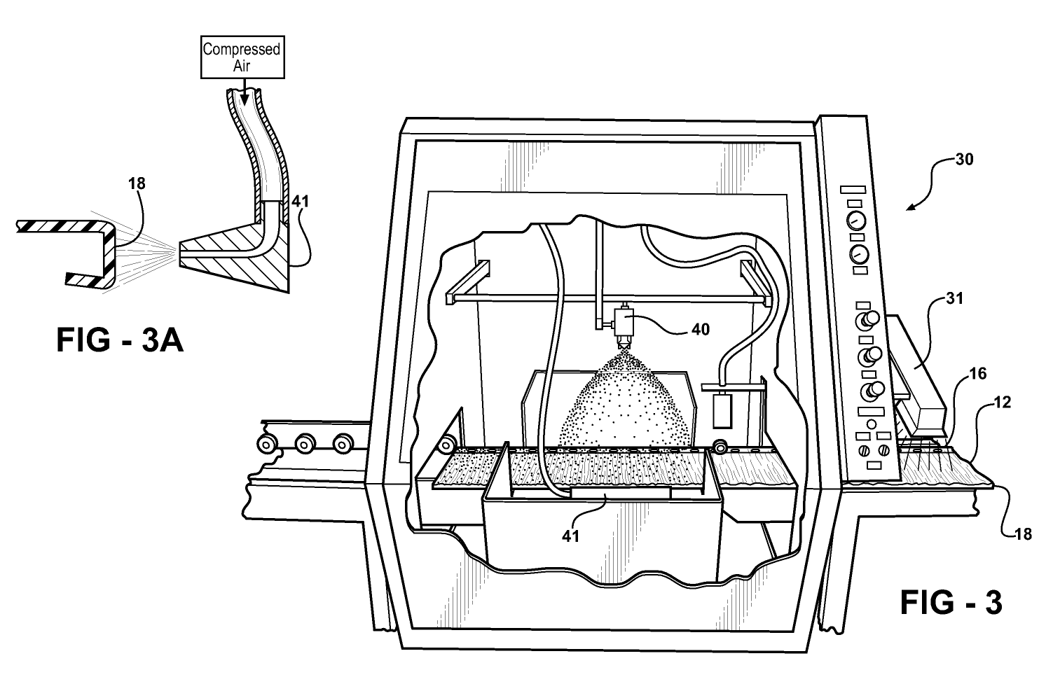

Referring to FIGS. 2 and 3, a conveyor 34 feeds the panels 12 through the system 10. The conveyor 34 may be any conventional conveying system suitable for moving the panels 12 between and through the painting station 30, the wiping station 32, and the curing station 28. For instance, the conveyor 34 may include a conveyor belt 36 supported by a plurality of rollers 37 with at least one of the rollers 37 being rotated by a suitable motor 38 to drive the conveyor belt 36 in a conventional manner. The conveyor 34 moves the panels 12 through the system 10 at a rate of from about 1 to about 100 feet per minute, more preferably from about 25 to about 60 feet per minute, and most preferably at about 50 feet per minute. In one embodiment, a plurality of conveyors 34 are used in the system 10 to provide separation between adjacent panels 12 as they pass through the system 10. For instance, separate conveyors 34 may: (1) feed the panels 12 into the painting station 30; (2) move the panels 12 out from the painting station 30 and to the wiping station 32; (3); move the panels 12 from the wiping station 32 to the curing station; and (4) move the panels out of the curing station 28. Each of the conveyors 34 moves slightly faster than the last to create a gap of separation between the panels 12.

Prior to the panel 12 entering the painting station, an anti-static device 31 removes areas of isolated static charge on the panel 12 that may attract paint to varying degrees. The anti-static device 31 may be an air knife or other suitable device. This provides a more uniform paint spread. At the painting station 30, an applicator 40 applies paint onto the surface of the panel 12. In the preferred embodiment, the paint is applied as very small specks or islands of paint onto the peaks 20 and valleys 22 of the panel 12. This results in a grainy appearance. For a 5 foot length of panel, the amount of paint applied would be from about 0.1 to about 10 grams, preferably from about 0.1 to about 4 grams, and most preferably from about 0.1 to about 3 grams. For a 10 foot length of panel, about 0.2 to about 20 grams of paint would be applied. Given the small amounts of paint that are used, the islands of paint deposited on the panel 12 are often spaced from one another.

Preferably, the paint is a second color different than the first color of the thermoplastic material to further create the variegated appearance. More preferably, the paint is an ultra-violet (UV) curable paint. The term color includes any color (including black and white), hue, shade, or combination thereof, which may be provided by the addition of any natural or synthetic coloring agents, pigments, and the like. The term color also includes multi-colored paint or multi-colored thermoplastic materials.

Referring to FIGS. 3 and 3A, an air knife 41 is mounted in the painting station 30 to direct a fluid stream, preferably a compressed air stream, toward the butt flange 18 of the panel 12. The air stream deflects particles of the paint from the applicator 40 toward the butt flange 18 to deposit the paint on the butt flange 18 such that the variegated appearance can be equally applied to the butt flange 18. The air knife 41 operates using principles well known to those skilled in the art and will not be described in detail.

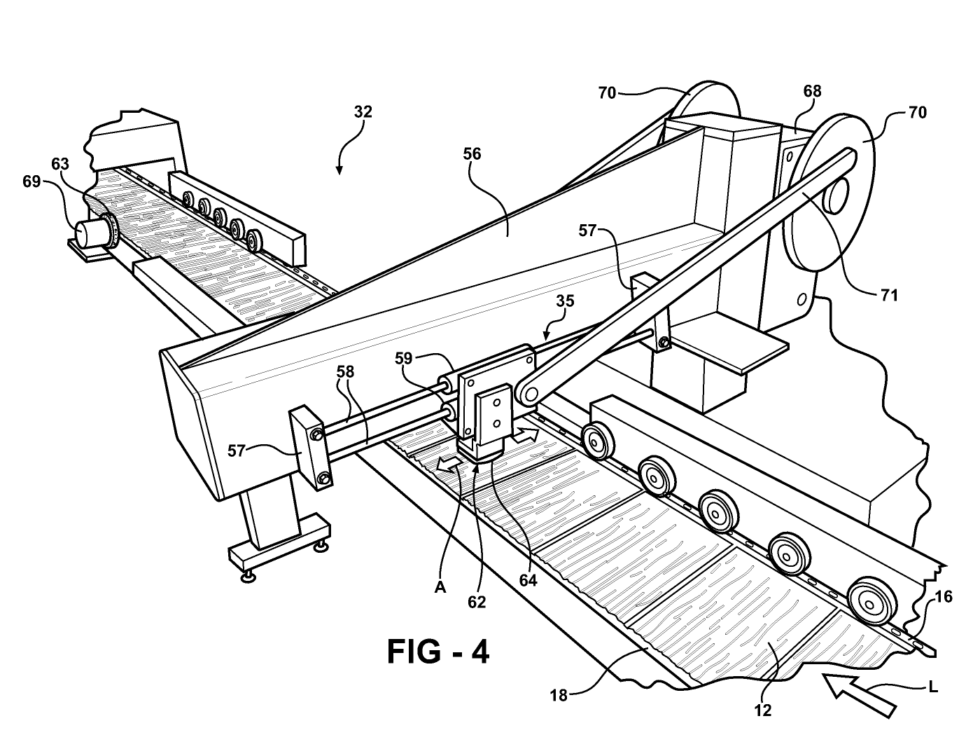

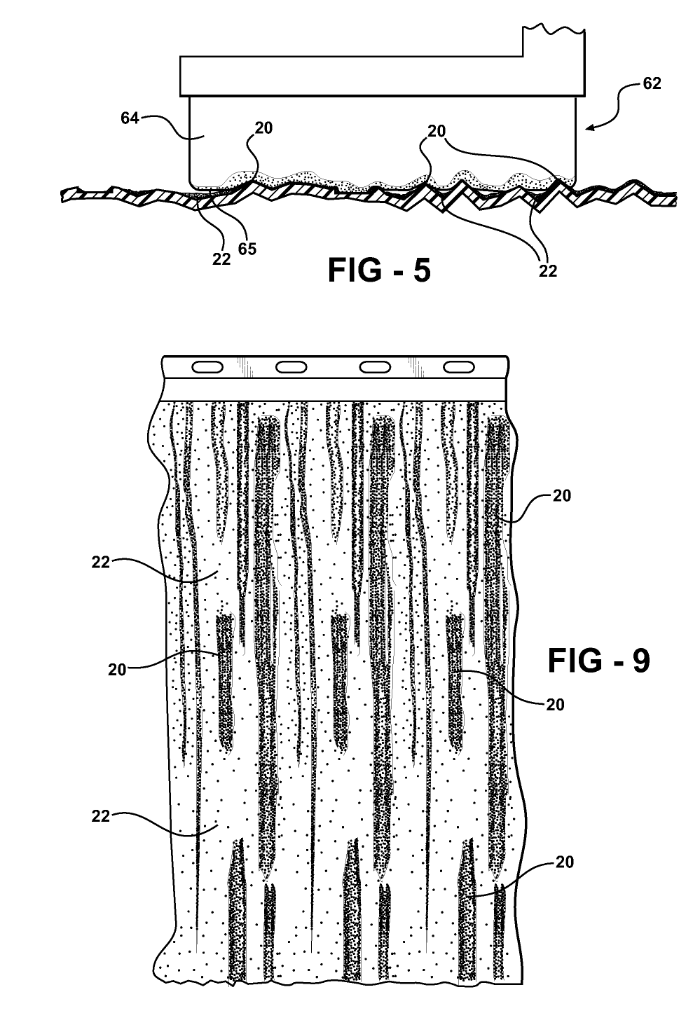

Referring to FIGS. 4 and 5, from the painting station 30, the panel 12 is passed through the wiping station 32, before the paint is cured. The panel 12 moves in a longitudinal direction L through the wiping station 32 on the conveyor 34. The wiping station 32 smears the paint along the peaks 20 without substantially touching the paint in the valleys 22 (see FIG. 5). Since the paint is being smeared along the peaks 20, yet remains untouched in the valleys 22, the variegated appearance is created on the panel 12. The smeared paint on the peaks 20 tends to assume a different appearance than the untouched paint in the valleys 22. Smearing the paint on the peaks 20 blends the spaced islands of paint together and gives the different appearance than the paint in the valleys 22, which remains substantially untouched and largely allows the color of the underlying thermoplastic material, which is different in color than the paint, to show through. In alternative embodiments, the paint is wiped along the peaks 20 to remove the paint substantially from the peaks 20 such that the underlying thermoplastic material is visible on the peaks 20. At the same time that the paint is removed from the peaks 20, the paint is relocated into the valleys 22 to cover the underlying thermoplastic material to give the variegated appearance.

The wiping station 32 includes at least one wiper 62 moving back and forth across the panel 12 in a lateral direction A to displace the paint along the peaks 20. Preferably, a plurality of wipers 62, moving in opposite directions, as discussed further below, smear the paint along the peaks 20, while the paint applied in the valleys 22 remains substantially untouched to give the variegated appearance.

A support structure 56 straddles the conveyor belt 36 to support the wipers 62. In FIG. 4, only a right side of the support structure is shown with a right side wiper 62, but the left side is identical to the right side, and carries its own left side wiper 62 (see FIG. 2). Thus, each of the components described below for driving the right side wiper 62 are mirrored on the left side for driving the left side wiper 62. The support structure 56 includes a pair of brackets 57 extending from the right side of the support structure 56 to carry a pair of rod-shaped tracks 58 that extend laterally across the conveyor belt 36. A mounting assembly 35 is slidably supported on the pair of rod-shaped tracks 58 by a pair of cylindrical bushings 59. The right side wiper 62 is fixed to the mounting assembly 35. An electric motor 68 is used to drive the mounting assembly 35 back and forth across the panel 12. A drive wheel 70 is turned by the electric motor 68 while a link 71 pivotally attaches the drive wheel 70 to the mounting assembly 35 such that rotation of the drive wheel 70 drives the mounting assembly 35 back and forth along the tracks 58. Preferably, the same electric motor 68 drives both the right and left side drive wheels 70.

The wipers 62 preferably move at a rate of from about 10 strokes per second to about 30 strokes per second. One stroke refers to one wiper 62 moving one width across the panel 12. Thus, one back and forth motion of one wiper 62 would equal two strokes. Preferably, the wipers 62 move at about 20 strokes per second. In the preferred embodiment, the wipers 62 positioned on opposite, right and left sides of the support structure 56 move in opposite directions to provide better wiping and balance inertia at the wiping station 32. In other words, when the right side wiper 62 is at the end of its forward stroke, the left side wiper 62 is at the end of its back stroke. The panels 12 preferably move into and through the wiping station 32 at a rate of from about 1 to about 100 feet per minute, more preferably from about 25 to about 60 feet per minute, and most preferably at about 50 feet per minute.

In operation, the wipers 62 move laterally across the width of the panel 12 in a reciprocating motion, i.e., from edge to edge, generally in the same direction as the peaks 20 and valleys 22. The peaks 20 and valleys 22 may not be completely straight from top edge to bottom edge, as some may veer to better simulate actual cedar shake shingles. The wipers 62 moves transversely, i.e., laterally, to the longitudinal movement of the panel 12 through the wiping station 32. The wipers 62 are substantially aligned with most peaks 20 and valleys 22 to move generally in the same direction as the peaks 20 and valleys 22. If the peaks 20 and valleys 22 are not completely straight, the variegated appearance on the panel 12 is more authentic.

The wipers 62 preferably include a non-absorbent, resilient pad 64. The pads 64 move back and forth across the entire width of the panel 12 in a reciprocating motion. The pads 64 have a width that is relatively small compared to a length of the panel 12 and preferably extends only across a predefined number of the peaks 20 and valleys 22. A plurality of pads 64 may be positioned within the wiping station 32 such that the individual pads 64 may be moved at a slower rate or such that the rate of longitudinal movement of the panel 12 may be increased.

The pads 64 preferably have a rough lower surface 65 that contacts the peaks 20 of the panel 12. Alternatively, the pads 64 could be notched to provide a plurality of tips. In other words, the pads 64 may be corrugated and may be flexible to increase the variegated appearance. The non-absorbent pads 64 smear the paint along the peaks 20, i.e., raised surfaces of the panel 12, without substantially touching the paint applied in the valleys 22. One type of preferred pad 64 is formed from a silicone foam rubber. However, similar materials having low absorption could also be used. In some instances, carpet pads may be used to smear the paint on the peaks 20. It should be appreciated that the pads 64, although previously described as smearing the paint along the peaks 20, actually smear the paint along the peaks 20 and along sides of the peaks 20 toward the valleys 22. The pads 64 are preferably flexible and compress on the peaks 20 such that parts of the pads 64 contact portions of the sides of the peaks 20. As a result, the variegated appearance is more authentic.

A secondary wiper 63 in the form of a rotating brush or rotating pad 63 of non-absorbent material may be rotatably mounted to a motor 69 on a side of the conveyor 34, as shown in FIG. 4. The rotating brush 63 smears the paint applied along the butt flange 18 of the panel 12 to ensure that the variegated appearance is also present on the butt flange 18. The rotating brush 63 may be disposed at an acute angle to the butt flange 18 such that the rotating brush 63 contacts the butt flange 18 along an outside edge thereof.

The tracks 58 at the wiping station 32 are generally parallel with the surface of the panel 12, such that the wipers 62 remains in contact with the surface as the wipers 62 move in the lateral direction A across each of the panels 12. In some embodiments, the wipers 62 may travel an inclined path because the butt flange 18 of the panel 12 is generally higher than the nail hem 16. However, the panel 12 is preferably positioned on the conveyor 34 such that the surface is horizontal and the wiping station 32 is not inclined.

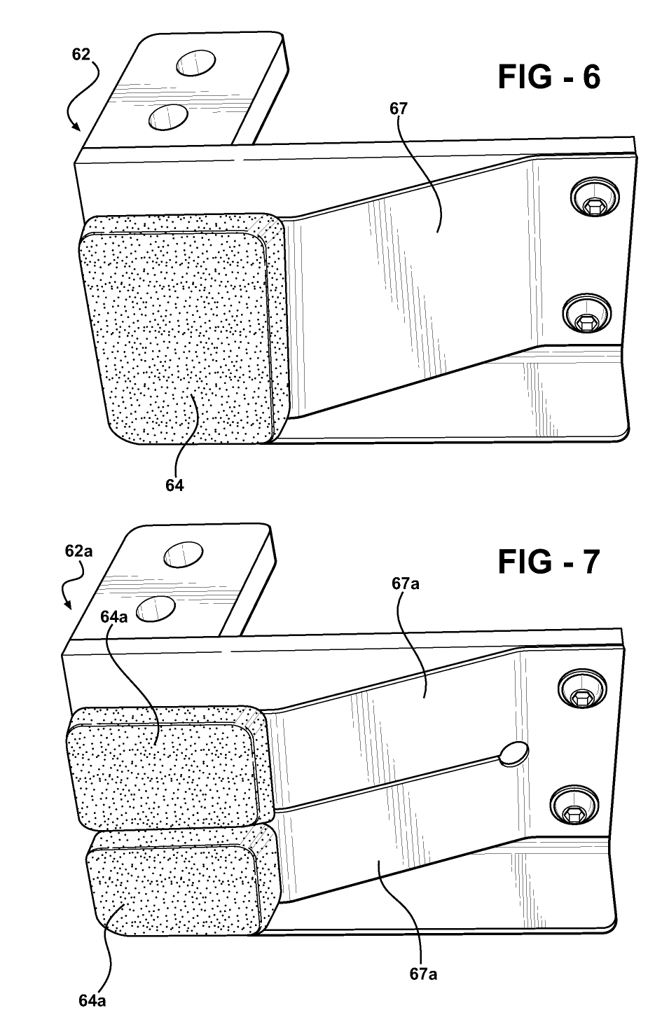

Referring to FIGS. 6 and 7, biasing members 67 in the form of leaf springs 67 or other suitable biasing mechanisms may be used to apply variable pressure to the panels 12 by the pads 64 at the wiping station 32. The springs 67 allow uneven peaks 20 to pass through the wiping station 32 without substantially altering the manner in which the paint is smeared along the uneven peaks 20. In some cases, the panels 12 may have large variations in peak height and the springs 67 allow the pads 64 to simply ride over these uneven peaks 20 as opposed to jarring the panels 12 when the higher peaks 20 are wiped. As shown in FIG. 6, one spring 67 is used to bias a single pad 64. Alternatively, in FIG. 7, two smaller pads 64a are biased by two smaller springs 67a. The use of a plurality of smaller pads 64a with smaller springs 67a in lieu of a single pad 64 and a single spring 67 further increases the potential variability in the pressure applied to the panels 12 by the pads 64, 64a.

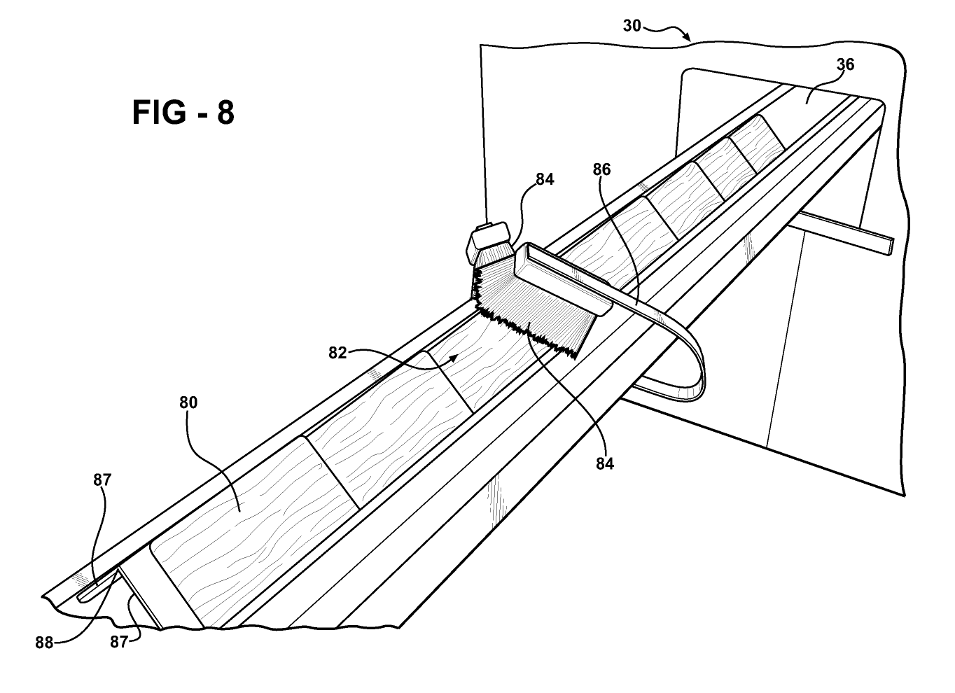

Referring to FIG. 8, the same processes applied to the panels 12 as described above may also be applied to corner posts 80 that are used at the corner of a building to conceal the laterally cut edges of the panels 12 in accordance with well known principles of construction. The posts 80 are also formed of a thermoplastic material and are passed through the painting station 30 to apply a thin layer of UV curable paint. Instead of passing through the wiping station 32 described above, each post passes through a post wiping station 82. The post wiping station 82 includes a pair of angled brushes 84 springably supported by a pair of arms 86 (only one arm shown in FIG. 8). In some embodiments, adjustment mechanisms (not shown) may be used to adjust the pressure of the brushes 84 upon the posts 80. The brushes 84 are preferably angled away from the longitudinal direction of movement of the post 80 on the conveyor belt 36 such that a front edge 87 of the post 80 contacts the brushes 84 prior to a peak 88 of the post 80 contacting the brushes 84. Thus, the front edge 87 urges the brushes 84 upwards to clear the peak 88.

Referring back to FIG. 2, once the panels 12 pass through the wiping station 32, the panels 12 are cured in the curing station 28. Depending upon the type of paint utilized, the curing station 28 may include heaters, blowers, or UV light sources. In the preferred embodiment, the paint that is applied to the panel 12 is a UV curable paint and the curing station 28 includes a UV light source 29, such as a plurality of UV lights 29. The panel 12 is exposed to the UV light source 29 for a sufficient amount of time to cure the paint, such as for 10 seconds. The conveyor 34 feeds the panel 12 through the curing station 28 and the panel 12 exits the curing station to be stacked or to be cut at the cutting station 26, in the event a continuous panel is being decorated. Since only a minimal amount of paint was applied to the panel 12, shorter periods of time may be used to sufficiently cure the paint. The posts 80 are similarly fed from the post wiping station 82 through the curing station 28.

By smearing the paint along the peaks 20 (and partly down the sides from the peaks 20) without substantially touching the paint applied in the valleys 22 (and partly up the sides from the valleys 22), striations are created extending in a vertical direction between laterally extending edges of the panel 12. FIG. 9 illustrates a panel 12 having the variegated appearance. The paint smeared along the peaks 20 (and partly down the sides from the peaks 20) assumes a darker appearance than that of the paint applied in the valleys 22 (and partly up the sides from the valleys 22).

While the invention has been described with reference to an exemplary embodiment, it will be understood by those skilled in the art that various changes may be made and equivalents may be substituted for elements thereof without departing from the scope of the invention. Therefore, it is intended that the invention not be limited to the particular embodiment disclosed as the best mode contemplated for carrying out this invention, but that the invention will include all embodiments falling within the scope of the appended claims.

What is claimed is:

1. A method of decorating a sheet of thermoplastic material formed with peaks and valleys of varying height extending between opposed edges, said method comprising the steps of:
applying paint to the peaks and valleys of the sheet of material wherein the sheet of material has a first color and the paint has a second color different than the first color;
advancing the sheet of material in a longitudinal direction with the peaks and valleys extending between the opposed edges in a lateral direction opposite to the longitudinal direction;
moving a wiper across the sheet of material in the lateral direction from edge to edge while advancing the sheet of material in the longitudinal direction and wiping the paint along the peaks in the lateral direction to provide the sheet of material with vertical striations extending in the lateral direction between the opposed edges.

2. A method as set forth in claim 1 wherein applying the paint to the sheet of material is further defined as applying a UV curable paint to the sheet of material.

3. A method as set forth in claim 2 including curing the UV curable paint after wiping the UV curable paint along the peaks to fuse the UV curable paint on the sheet of material to the sheet of material.

4. A method as set forth in claim 1 wherein wiping the paint along the peaks includes smearing the paint along the peaks while the paint remains substantially untouched in the valleys of the sheet of material to differentiate the peaks from the valleys of the sheet of material.

5. A method as set forth in claim 1 wherein moving the wiper across the sheet of material laterally from edge to edge includes reciprocating the wiper across the sheet of material from edge to edge in the lateral direction.

6. A method as set forth in claim 1 wherein applying the paint to the sheet of material includes spraying the paint onto the sheet of material at a painting station.

7. A method as set forth in claim 6 including continuously advancing the sheet of material through the painting station in the longitudinal direction while spraying the paint onto the sheet of material and wherein advancing the sheet of material in the longitudinal direction includes continuously advancing the sheet of material through a wiping station in the longitudinal direction while moving the wiper at the wiping station laterally across the sheet of material in the lateral direction and wiping the paint along the peaks of the sheet of material in the lateral direction.

8. A method as set forth in claim 1 including biasing the wiper into contact with the peaks of the painted sheet of material simultaneously to simultaneously wipe the paint along the plurality of the peaks of the painted sheet of material.

9. A method as set forth in claim 1 wherein curing the UV curable paint includes directing a UV light source onto the UV curable paint.

10. A method as set forth in claim 3 including cutting the sheet of material after curing the UV curable paint to form a plurality of decorative building panels.

11. A method as set forth in claim 1 wherein the sheet of material is a building panel.

12. A system for decorating a sheet of thermoplastic material formed with peaks and valleys of varying height extending between opposed edges, said system comprising:
a painting station including an applicator for applying paint to the peaks and valleys of the sheet of material whereby the sheet of material has a first color and the paint has a second color different than the first color;
a wiping station spaced from said painting station and including a wiper for wiping the paint along the peaks; and
a conveyor for advancing the sheet of material through said wiping station in a longitudinal direction with the peaks and valleys extending between the opposed edges in a lateral direction opposite to the longitudinal direction,
said wiper being movable in the lateral direction opposite to the longitudinal direction of advancement of said conveyor to wipe the paint along the peaks in the lateral direction to provide the sheet of material with vertical striations extending in the lateral direction between the opposed edges.

13. A system as set forth in claim 12 including a curing station spaced from said painting station and said wiping station and including a UV light source for curing the paint to fuse the paint to the sheet of material after wiping the paint along the peaks.

14. A system as set forth in claim 12 wherein said painting station includes a paint booth and a support mounted to said paint booth, said applicator being mounted to said support such that said applicator applies the paint to the sheet of material from above the sheet of material.

15. A system as set forth in claim 12 wherein said wiping station includes a support structure and a reciprocating device mounted to said support structure, said wiper being supported by said reciprocating device for wiping said paint from the peaks of the sheet of material in a reciprocating manner in the lateral direction.

16. A system as set forth in claim 12 including a biasing member operatively coupled to said wiper for biasing said wiper into contact with the peaks of the sheet of material as the sheet of material continuously advances in the longitudinal direction.

17. A system as set forth in claim 12 including a plurality of wipers and a plurality of biasing members operatively coupled to said plurality of wipers for biasing said wipers into contact with the peaks of the sheet of material as the sheet of material continuously advances in the longitudinal direction.

18. A system as set forth in claim 12 wherein said wiper is formed of a non-absorbent material.

19. A system as set forth in claim 18 wherein said wiper is formed of a silicone foam rubber.

20. A panel for decoratively covering a support surface, comprising:
a sheet of material having a top and a bottom and first and second ends, said sheet of material being formed of a first color;
a mounting flange adjacent said top;
a butt flange adjacent said bottom;
a plurality of peaks and valleys of varying height extending between said top and bottom;
a UV curable paint of a second color different than said first color fused to said sheet of material on said peaks and in said valleys, wherein said UV curable paint is deposited as separate islands of paint on said sheet of material with said islands being smeared together along said peaks and substantially untouched in said valleys such that said peaks have a different appearance than said valleys.
